(19) United States
(12) Patent Application Publication
(10) Pub. No.: US 2004/0158499 A1
(43) Pub. Date: Aug. 12, 2004

(54) System and method for providing self-service restaurant ordering and payment

(76) Inventors: Roger H. Dev, Durham, NH (US); Mark Samber, Portsmouth, NH (US); Michaleen D. Craig, Stratham, NH (US); Alyssa E. Mckenzie, Goffstown, NH (US); Kelly Ward, Barrington, NH (US)

Correspondence Address: HAYES SOLOWAY P.C., 175 Canal Street, Manchester, NH, 03101, US

(21) Appl. No.: 10/620,717

(22) Filed: Jul. 16, 2003

Related U.S. Application Data
(60) Provisional application No. 60/396,187, filed on Jul. 16, 2002.
(60) Provisional application No. 60/396,188, filed on Jul. 16, 2002.

(51) Int. Cl. G06F 17/60

(52) U.S. Cl. 705/26

(57) ABSTRACT

A system has a graphical use interface that allows a user to select desired items through either a data-entry-terminal located on-site at a restaurant or store or through a network, for example a network utilizing the Internet. The system may also allow an order to be customized and stored in memory for later recall.

### CROSS-REFERENCE TO RELATED APPLICATIONS

This application claims priority to copending U.S. Provisional Patent Application Serial No. 60/396,187, filed on Jul. 16, 2002, the entire disclosure of which is incorporated herein by reference in it entirety. This application is also related to copending U.S. provisional patent application entitled “Method and Apparatus for the Management of Private Consumer Accounting Using Branded Loyalty Cards and Self-Service Terminals,” filed on Jul. 16, 2002 and accorded serial No. 60/396,188 and its corresponding utility patent application filed Jul. 16, 2003, both of which are incorporated herein by reference in their entirety.

### FIELD OF THE INVENTION

The present invention relates to the field of order processing in the quick-serve restaurant (QSR) industry and other industries with similar customer ordering characteristics, and more particularly to a system and method for automating the ordering and payment process.

### BACKGROUND

The restaurant industry, historically, divides its labor into two major areas, namely food preparation and customer service. Customer service includes the roles of: host /hostess, waiter/waitress, counter-service, bartender, bus-person, etc.

For the QSR segment of the restaurant industry, the customer-service role is typically focused on counter or drive-through service. Personnel typically receive a verbal order from the customer, enter the order into a point-of-sale (POS) terminal (or alternatively write it down on paper), tell the consumer the total, collect the money, provide change, and present prepared food to the consumer. The customer-service function is typically mundane and repetitive and provides little added value to the experience of the consumer. The customer-service function is at the same time expensive to staff and manage and involves significant training.

Standard items available at a QSR are typically displayed on a static menu board. A customer begins the ordering process by telling an order taker, either in person or through a drive-through kiosk, a list of the desired items along with any modifications to the items. The order taker manually enters the order into a POS terminal for processing by a back-end system.

A typical menu board at a fast food restaurant, sandwich, pizza, or donut shop may have thirty (30) or more items available for ordering. Items are typically displayed at all times although certain items may only be available during certain time periods and certain items may be out of stock. For example, a restaurant may only serve eggs before 10:30; omelets may only be available on the weekends; and lobster may only be available during the summer. These menu boards also fail to provide the opportunity to adapt to regional preference, accommodate loyal customers, enhance the ordering experience, and improve order accuracy and delivery.

There is a need for a menu presentation and ordering system and method that can overcome shortcomings of existing systems and methods.

### BRIEF SUMMARY OF THE INVENTION

Embodiments of the present invention provide a system and method for providing self-service ordering and payment.

Briefly described, in architecture, one embodiment of the system, among others, can be implemented as follows. An apparatus for displaying a menu includes a data input device, a storage device of item types, sub item types, and items available for sale, a video display terminal, and a program configured to display a first level of item types from the storage device in a first zone of the video display terminal for a user to select from, a second level of sub item types in a second zone of the video display terminal for a user to select from while maintaining viewability of the first zone, and a third level of items in a third zone of the video display terminal for a user to select from while maintaining viewability of the first and second zones.

The present invention can also be viewed as providing a method of displaying a menu including the steps of displaying a first level of item types in a first zone, receiving a first input from a user of a desired item type from the first level, displaying a second level of sub item types from the desired first item type in a second zone while maintaining viewability of the first zone, receiving a second input from a user of a desired sub item from the second level, and displaying a third level of items from the desired second sub item type in a third zone while maintaining viewability of the first and second zones.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. Components in the drawings are not necessarily to scale, emphasis instead being placed upon clearly illustrating principles of the present invention. Moreover, in the drawing, like reference numerals designate corresponding parts throughout the several views.

FIG. 1 is a top view of a single-restaurant deployment employing the present self-service system in accordance with a first exemplary embodiment of the invention.

FIG. 2 is a top view of a multiple-restaurant deployment employing the present self-service system in accordance with a second exemplary embodiment of the invention.

FIG. 3 is a schematic view of a self-service terminal in accordance with the first exemplary embodiment of the invention.

FIGS. 4A and 4B are side and front views, respectively, of a countertop enclosure for housing a data entry terminal in accordance with the first exemplary embodiment of the invention.

FIGS. 5A and 5B are side and front views, respectively, of a pedestal enclosure for housing a self-service terminal in accordance with a third exemplary embodiment of the invention.

FIGS. 6A and 6B are side and front views, respectively, of a drive-through enclosure for housing a self-service terminal in accordance with a fourth exemplary embodiment of the invention.

FIG. 7 is a system diagram for an ordering system in accordance with the first exemplary embodiment of the invention.

FIG. 8 is a graphical image or graphical user interface (GUI) in accordance with the first exemplary embodiment of the invention.

FIG. 9 is a flow chart illustrating a menu presentation method in accordance with the first exemplary embodiment of the invention.

FIGS. 10A- 10C are graphical images or GUI in accordance with the menu presentation method illustrated in FIG. 9.

FIG. 11 is a flow chart illustrating an option menu presentation method in accordance with the first exemplary embodiment of the invention.

FIGS. 12A- 12C are graphical images or GUI in accordance with the option menu presentation method illustrated in FIG. 11.

FIG. 13 is a flow chart illustrating a menu presentation method in accordance with a fifth exemplary embodiment of the invention.

FIG. 14 is a graphical image or GUI in accordance with the menu presentation method illustrated in FIG. 13.

FIG. 15 is a flow chart illustrating a menu presentation method in accordance with a sixth exemplary embodiment of the invention.

FIGS. 16A-16D are graphical images or GUI in accordance with the menu presentation method illustrated in FIG. 15.

FIG. 17 is a flow chart illustrating an ordering method in accordance with a seventh exemplary embodiment of the invention.

FIG. 18 is a flow chart illustrating an ordering method in accordance with an eighth exemplary embodiment of the invention.

FIG. 19 is a flow chart illustrating a menu presentation method in accordance with a ninth exemplary embodiment of the invention.

FIG. 20 is a flow chart illustrating a menu presentation method in accordance with a tenth exemplary embodiment of the invention.

FIGS. 21A-21C are graphical images or GUI in accordance with the menu presentation method illustrated in FIG. 20.

FIG. 22 is a flow chart illustrating an ordering method in accordance with a eleventh exemplary embodiment of the invention.

FIG. 23 is a flow chart illustrating a presentation method in accordance with a twelfth exemplary embodiment of the invention.

FIG. 24 is a flow chart illustrating a presentation method in accordance with a thirteenth exemplary embodiment of the invention.

### DETAILED DESCRIPTION

The present invention is a system and method for providing self-service ordering and payment. Specifically the system and method is used to accept orders and payment for items to be prepared, for example, food items ordered through a kiosk at a fast food restaurant or through a network, for example, the Internet. Although the particular examples discuss an application for use with food, it is understood that other items that lend themselves to a self-service kiosk are contemplated.

The present invention can be implemented in hardware, software, firmware, or a combination thereof. In accordance with the exemplary embodiment described below, portions implemented in software or firmware are stored in a memory and are executed by a suitable instruction execution system located in a central processing unit (CPU). Portions implemented in hardware, as in an alternative embodiment, can be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

A self-service approach to quick-serve restaurant (QSR) customer-service may offer a number of benefits to the consumer including faster order processing time; reduced frustration; reduced mis-orders and corresponding disappointment or return; reduced time waiting in line; increased perception of privacy; and availability of “enhanced” services that are not available through traditional means.

In addition, embodiments of the invention may provide advantages to the merchant including: competitive differentiation for a subset of customers; reduction of required staff; reduction of mis-orders; uniform up-sell capabilities; add-on revenue potential (e.g., advertising); opportunity for additional interaction with customer through offerings such as customer loyalty programs and games; extensive customer, menu and terminal usage data; and automatic menu changeover based on time-of-day (e.g., breakfast to lunch and lunch to dinner), day of the week, day of the year, and present weather conditions.

A system consistent with the present invention may provide economical self-service ordering and payment terminals (in restaurant self-service terminals and drive-through terminals. The system may be intuitive, i. e., easy to use; centralized, offer easy-to-maintain menu and store definitions; offer tie-ins capabilities to existing point-of-sale (POS) and kitchen systems; and offer publicly accessible Website ordering and enhanced services.

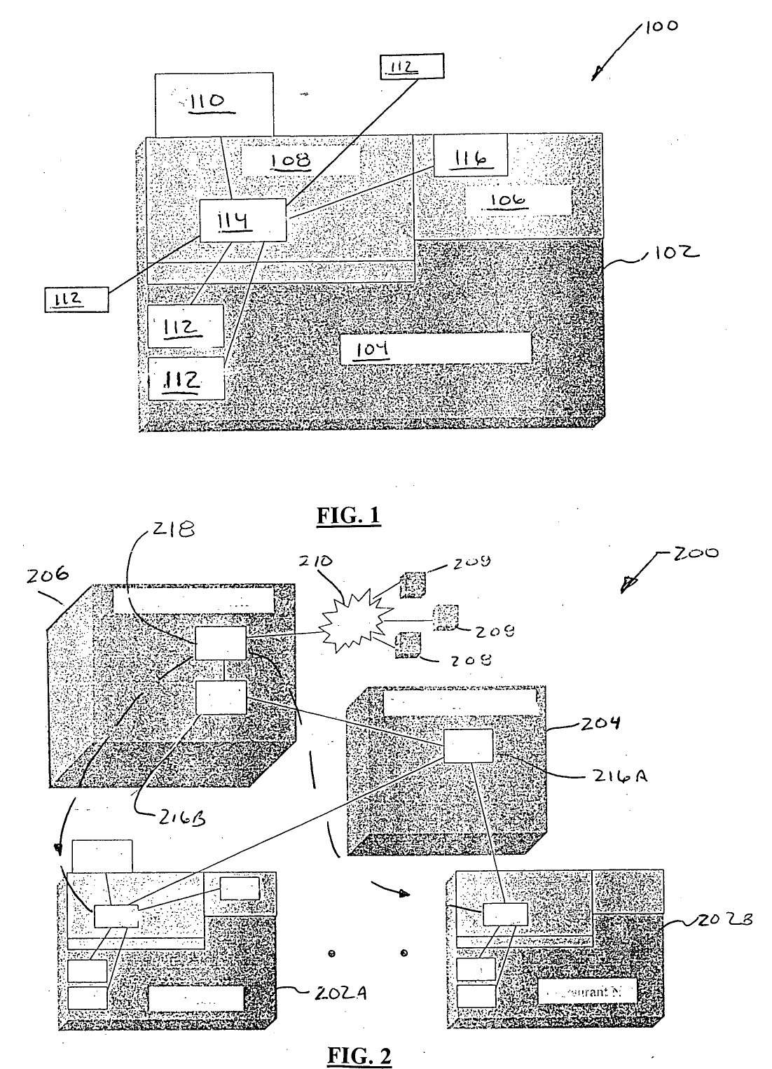

FIG. 1 is a top view of a single-restaurant deployment 100 employing the present self-service system in accordance with a first exemplary embodiment of the invention. A restaurant 102 may be divided into functional areas, for example a dining area 104, an office 106, a kitchen 108, and a drive-through area 110. One or more data-entry terminals 112 may be located in the dining area 104. A data-entry terminal may be any device through which an order can be composed. Alternatively, the data-entry terminals 112 may be located outside of the restaurant 102. The data-entry terminal 112 may be coupled to a transaction manager 114 located within the restaurant 102, which in turn may communicate with a unit back office service suite (uBOSS) 116, possibly located in the office 106. The transaction manager 114 is capable of communicating with existing kitchen systems.

FIG. 2 is a top view of a multiple-restaurant deployment 200 employing the self-service system, in accordance with a second exemplary embodiment of the invention. The deployment 200 may have one or more restaurants 202A, 202B, a regional facility 204, and a national facility 206. The regional facility 204 and the national facility 206 may each have a regional back office service suite (rBOSS) 216A, 216B. The national facility 206 may have a CPU 218 with virtual self-service terminal (V-SST) software and/or firmware. One or more users 208 may communicate with the national facility 206 through a network 210, for example a network utilizing the Internet. The CPU 218 may communicate with the transaction managers 114 directly or through the rBOSS 216A, 216B. The V-SST software may allow a user to order items, for example food orders, for pick up at a desired pick-up location. The user can access the V-SST software through an electronic device, for example a computer, personal digital assistant (PDA), phone, or vehicle navigational system.

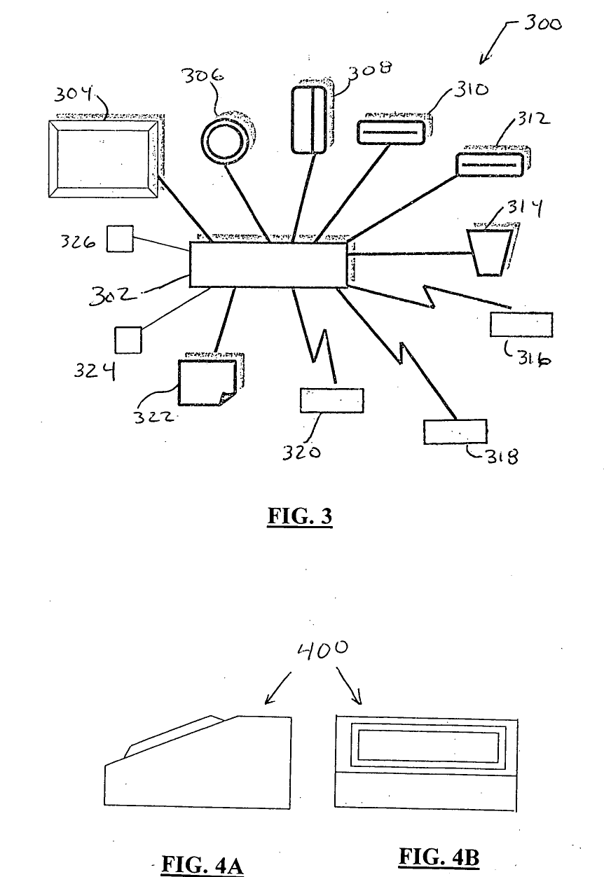

FIG. 3 is a schematic view of a self-service terminal (SST) 300 in accordance with the first exemplary embodiment of the invention. The self-service terminal 300 may be a data-entry terminal 112 with payment capabilities, i.e., allows a user to pay for their order. The self-service terminal 300 may have a base unit 302, for example a CPU or other suitable hardware and/or firmware. The CPU may have appropriate software or firmware. The base unit 302 may be coupled to peripheral components. Peripheral components may include an input device, for example a touch screen 304, a radio frequency reader 306, a credit, debit, or loyalty card reader 308, a bill acceptor 310, a bill dispenser 312, a coin acceptor/-dispenser 314, a communications port 316 for communicating with other self-service terminals, a modem 318 for credit card authorization, a communications port 320 to communicate with back-end systems, a receipt printer 322, a speaker 324, and a microphone 326. The communications port 316 may be wired or wireless and may be, but is not limited to Ethernet or RS232.

The self-service terminal 300 may allow customers to compose orders and pay for them using a variety of payment methods including: radio frequency identification (RFID) (e.g., speedpass), credit card, debit card, cash, or loyalty card. The self-service terminal 300 may submit the order for preparation through the transaction manager 114.

A variety of enclosure types for housing data entry terminal 112 include, a countertop enclosure, a pedestal enclosure, for example a kiosk, a drive-through enclosure, and a frame enclosure.

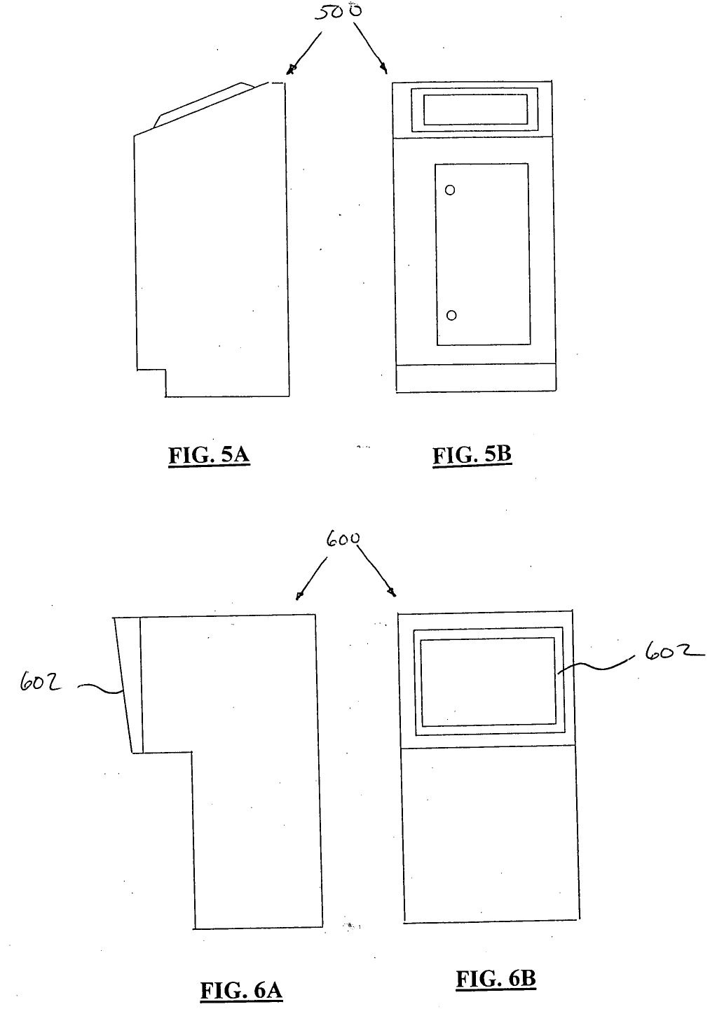

FIGS. 4A and 4B are side and front views, respectively, of a countertop enclosure 400 for housing a data-entry terminal 112 in accordance with the first exemplary embodiment of the invention. The countertop enclosure 400 may be for use by store employees or in environments where a pedestal enclosure (see FIG. 5) is undesirable. The countertop enclosure 400 may be limited in its ability to handle larger peripherals such as a bill acceptor 310, a bill dispenser 312, and a coin acceptor/-dispenser 314. The countertop enclosure 400 is intended for use with a radio frequency reader 306 and a card reader 308 or a cash box for behind-the-counter operations.

FIGS. 5A and 5B are side and front views, respectively, of a pedestal enclosure 500 for housing a self-service terminal 300 in accordance with a third exemplary embodiment of the invention. The pedestal enclosure 500 is primarily for use by customers indoors in a supervised environment, for example inside the dining area 104 of a restaurant 102. A front-opening door preferably includes steel double barrel locks, but may not be steel reinforced. The pedestal enclosure 500 may have a first exterior door with a lock that allows access to system electronics, but not money, for example cash, coins, and credit/debit information. A second interior door with a lock allows access to the money. The two-door system allows service personnel to fix the enclosure 500, but prevents the service personnel from accessing the money. The pedestal enclosure 500 may have necessary peripheral components, for example a touch screen 304, a radio frequency reader 306, a card reader 308, a bill acceptor 310, a bill dispenser 312, a coin acceptor/dispenser 314, a communications port 316, a modem 318, a communications port 320, and a receipt printer 322, in order to receive an order, accept payment, return overpayment, and send the order to the restaurant for preparation. The pedestal enclosure 500 may have a speaker 324 to listen to audio messages and a microphone 326 to communicate with an order taker if the user encounters problems.

FIGS. 6A and 6B are side and front views, respectively, of a drive-through enclosure 600 for housing a self-service terminal 300 in accordance with a fourth exemplary embodiment of the invention. The drive-through enclosure 600 is preferably designed to provide a secure, weather tight environment and can accommodate any of the peripheral options. A touch screen 602 may be cantilevered forward for convenient access from vehicles. Security may be provided by a reinforced steel shell and double barrel locks. Referring to FIG. 3 as well, a built in call button, microphone 326 and speaker 324 allow interaction with human order-takers in case the customer wishes to bypass the self-service capabilities.

An open-frame enclosure may contain all the peripheral components of the self-service terminal 300 in an open frame that can be embedded within existing or new cabinetry at the QSR.

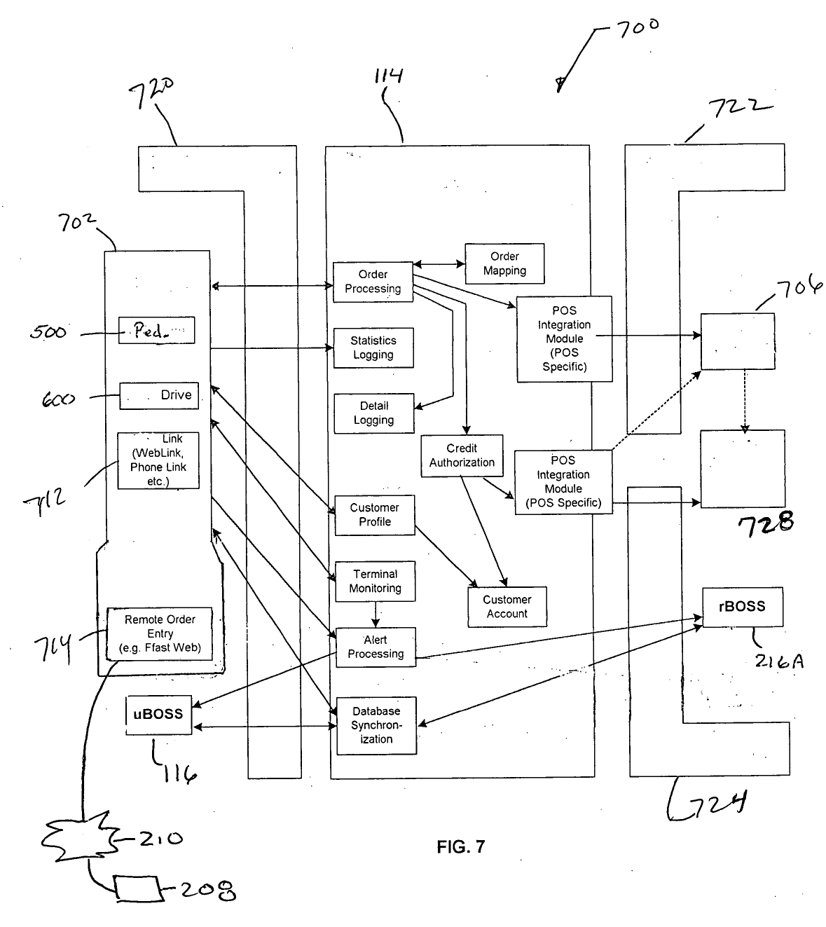

FIG. 7 is a system diagram for an ordering system in accordance with the first exemplary embodiment of the invention. The system 700 may have customer touch points 702, a transaction manager 114, a point-of-sale system 706, a unit BOSS (UBOSS) 116, and a regional BOSS (rBOSS) 216A. The customer touch points 702 may include data-entry terminals 112, for example, self-service terminals 300 within a pedestal enclosure 500 or a drive-through enclosure 600, an electronic device 712, for example a PDA, vehicle navigation system, automobile transponders, and cell phone located in or near the restaurant, and a network connected device 714, for example an electronic device coupled through the Internet. The PDAs, vehicle navigation systems, automobile transponders, cell phones, and other electronic devices may access the system 700 using virtual self-service terminal (V-SST) software. The customer touch points 702 may be connected to the transaction manager 114 through local area network (LAN) connectivity 720 and the rBOSS 216A may be connected to the transaction manager 114 through wide area network (WAN) connectivity 724. Of course, other connectivity may be utilized as well.

The transaction manager 114 may provide an interface between the customer touch points 702 and the point-of-sale system 706. Interaction with food preparation personnel may employ a number of mechanisms, including, but not limited to, a receipt printer where duplicates of the customer receipt are printed in the kitchen 108 and may be used to drive order fulfillment; a touch screen where orders may be viewed on one or more touch-screen monitors and may be deleted once the order is fulfilled; and an integrator where integration with existing back-end or food preparation system can be accomplished and orders may be fed into an existing kitchen system.

The transaction manager 114 can also act as a gateway for communication with the uBOSS 116 or the rBOSS 216A and with a credit authorization service bureau 728.

The transaction manager 114 can run within any of the data-entry terminals 112 or can be run from a dedicated CPU, for example a PC-based appliance, if the restaurant configuration does not allow easy access between one of the data-entry terminals 112 and the kitchen 108.

The uBOSS 116 may provide a number of capabilities to support the restaurant operator and managerial staff, including, but not limited to: menu definition and maintenance; terminal control and configuration; statistical reporting; terminal statistics (e.g., orders completed, orders abandoned, average order time, average items per order, average order price, average clicks per order, orders per time-of-day, payment methods, etc); menu statistics (e.g., how many of each item and option); and order detail logging which may include items ordered, cash and credit reconciliation.

The rBOSS 216A, may allow multiple restaurants 202A, 202B to be controlled and monitored from a central site such as the regional facility 204 or the national facility 206 (see FIG. 2). An rBOSS 216B at the national facility 206, such as a corporate headquarters can, in turn, control multiple rBOSSes 216A located in the regional facilities 204. This configuration of uBOSSes 116 and rBOSSes 216A, 216B may allow construction of a distributed control and monitoring infrastructure that can be scaled to handle even the largest restaurant chains. The rBOSS 216A may also communicate with a transaction manager 114 in a restaurant 202B that does not have a local uBOSS.

The rBOSS 216A may provide the following features in addition to the capabilities of the uBOSS 116: an industrial strength database; the ability to create and maintain restaurant profiles; and the ability to create and maintain adaptive menus that allow a single menu definition to adapt based on restaurant capabilities defined in restaurant profiles (discussed below).

TheV-SST software may provide a Web-based interface allowing customers to access a V-SST from any electronic device, for example an internet connected device. Using possibly the same visual interface as the in-restaurant self-service terminal 300, the V-SST software may allow the customer to compose orders and submit them to any of the chain's restaurants. In addition, the V-SST software may provide features that may not be available at the self-service terminal 300 such as the ability to create and save custom order items or entire orders. The custom order items or entire order may then appear on the self-service terminal menu at favorite restaurants of the customer as a custom selections that can be ordered with a single click.

The V-SST software may provide the restaurant chain with significant opportunities to engage the customer once the customer has entered a specific Website. A V-SST can appear to the rBOSS 216A, 216B as a “virtual restaurant” with an unlimited number of self-service terminals. The control functions of the rBOSS 216A, 216B likewise may control the operation of the virtual self-service terminal.

The V-SST software offerings may be based around a common menu and ordering interface. This same interface may be used within the customer touch points 702, the uBOSS 116 and the rBOSS (for defining menus) 216A, 216B and the virtual self-service terminals 714. The virtual self-service terminal may have an extremely intuitive interface that can be used with little or no training. The V-SST software may drive the interface in each of these environments. Use of the V-SST software may improve reliability and usability while decreasing development costs by being capable of use for multiple functions as described herein.

The V-SST software may include customer and operator features. The customer features may include, but are not limited to, an attractive, appealing presentation; flexible payment methods for example cash, credit, debit, RFID, pay-at-counter or in-house debit accounts/gift certificates or loyalty cards; a multi-lingual interface in which customers can select the language in which to operate; a see and click approach to choosing menu items which allows users to simply click on a picture or icon representing the food they want; expandable menu categories that allow the handling of large menus in limited space without losing context; an on-screen receipt display that shows the order along with subtotal, tax and the total as the order being composed; the ability to customize an item with any available toppings or options including combos and special offers; a common interface for in-restaurant and from-home (Internet) use; and the ability to define and save custom selections using a V-SST and access them through an SST at a favorite restaurant.

Operator features, may include, but are not limited to, a flexible menu system that can handle virtually any menu and may be completely database driven; a menu item customization capability that allows multiple methods of selecting options (to be discussed below); a menu that can be easily maintained by restaurant personnel employing the same visual interface used for ordering; appearance attributes such as colors, images and fonts that can be tailored to the restaurant chain; an up-sell capability that allows users to be prompted for additional items or larger sizes (e.g., would you also like a dessert?); adaptive menus that allow the same menu database to automatically adapt to the limitations or capabilities of a given restaurant; multiple payment methods; a system that creates a reason for customers to visit a restaurant Website, enabling opportunities for additional marketing and promotion activities; the ability to integrate with existing back-end systems; the ability to centrally manage many terminals; extensive statistics on terminal usage and payment methods as well as food item and option details; full order logging available at each level; the ability to alert restaurant personnel of any servicing needs; wireless communication between all components within a restaurant; and encryption between all components.

As noted above, statistics may be tracked at each level of the system. Statistics may include, but are not limited to, system statistics relating to the use of the self-service terminal 300 and virtual self-service terminal 714, and menu statistics relating to the ordering patterns of food items.

System statistics may include, but are not limited to, order composition statistics, which may include quantity of orders completed; quantity of orders started; quantity of incomplete orders; order completion ratio, i.e., orders completed/orders started; mean order completion time, i.e., the total time a customer is at the terminal for completed orders; mean composition time, i.e., the time to choose items and select payment method; mean payment time, i.e., the time to enter payment media; mean processing time, i.e., the time after payment media entered until order complete; mean authorization time, i.e., the time for credit authorization; mean actions per order, i.e., the number of user actions (e.g., screen touches, mouse clicks) required to complete the average order; and mean items per order, i.e., the number of items ordered.

Payment statistics may include, but are not limited to, payment method counters that record the usage of the different payment options including, the use of speedpass, credit, debit, and cash at the self-service terminal 300 or payment at a pick -up window or counter; and payment amount counter which record the mean order value, total order value, cash in, cash out, net cash, credit value, debit value, speedpass value, and payment at the pick-up window or counter.

Menu statistics may include, but are not limited to, counts by item name; counts by item name and option, i.e., the number of times each option was ordered for a given item; and counts by option name i.e., the number of times each option was ordered across all items.

Standard alerts may be provided at the transaction manager 114, uBOSS 116, and rBOSS 216A, 216B. Flexible notification methods may allow redirection of various alerts to notification mechanisms such as pagers, phone, or onto existing system terminals. This allows, for example, dispatching regional maintenance rather than restaurant personnel for some or all service tasks. Where possible, alerts are preferably sent before the service is needed. For example, when paper is nearing empty or the bill acceptor is nearing capacity.

Alerts include, but are not limited to, terminal offline, i.e., a terminal has stopped responding to the transaction manger 114 (e.g., power failure); terminal malfunction, e.g., a hardware unit within the terminal requires servicing (e.g., paper-low; paper-out; bill acceptor near capacity; bill acceptor full; coins low; coins empty; bill dispenser low; and bill dispenser empty).

The transaction manager 114 may provide a common set of terminal support services that may be utilized by any of the customer touch points 702. The transaction manager 114 may handle the order processing, customer profile access, statistics logging, and alert processing. The order processing may receive order content and instructions from the customer touch point 702; authorize credit and debit purchases through the credit authorization bureau 728; map content to POS implementation specific identifiers via order mapping service; forward the mapped order to the active POS integration module; log the order using detail logging service; and return confirmation (success or failure) to the customer touch point 702. The customer profile access may provide a read profile and a write profile. The statistic logging may store a set of session statistics into a session statistics database. The alert processing may send received alerts from the customer touch point 702 or internally generated to the appropriate destination as configured, for example a local display device, an uBOSS 116, a rBOSS 216A, 216B, or other device, for example a pager, cell phone, or e-mail address.

The transaction manager 114 may periodically, on a configured interval (e.g., 60 seconds), poll each self-service terminal 300 using the status inquiry service of the self-service terminal 300, to verify that the self-service terminal 300 is reachable and operating normally. This is a failsafe mechanism to handle cases where the self-service terminal 300 is impaired to an extent that it cannot send self-diagnostic alerts (e.g., power-failure, communications-failure, process-failure).

Other services may not interface directly with the customer touch points 702, but may be used by other services within the transaction manager 114 including: detail logging which may be used by order-processing at the conclusion of an order; order mapping which may map the canonical order semantic to a POS and installation specific semantic (POSISS) base on the contents of the installation's POS mapping rules table; credit authorization which may approve or reject a credit or debit request given an account ID, variable payment information (e.g., expiration date, PIN, user-name, etc.), and an amount; customer account which may be used to access or modify private account information including balance and limits; POS integration module(s) which may provide a common service interface for interfacing with POS systems; credit authorization integration module(s), which may provide a common service interface for accessing external credit authorization service. Each module may interface to one type of authorization service.

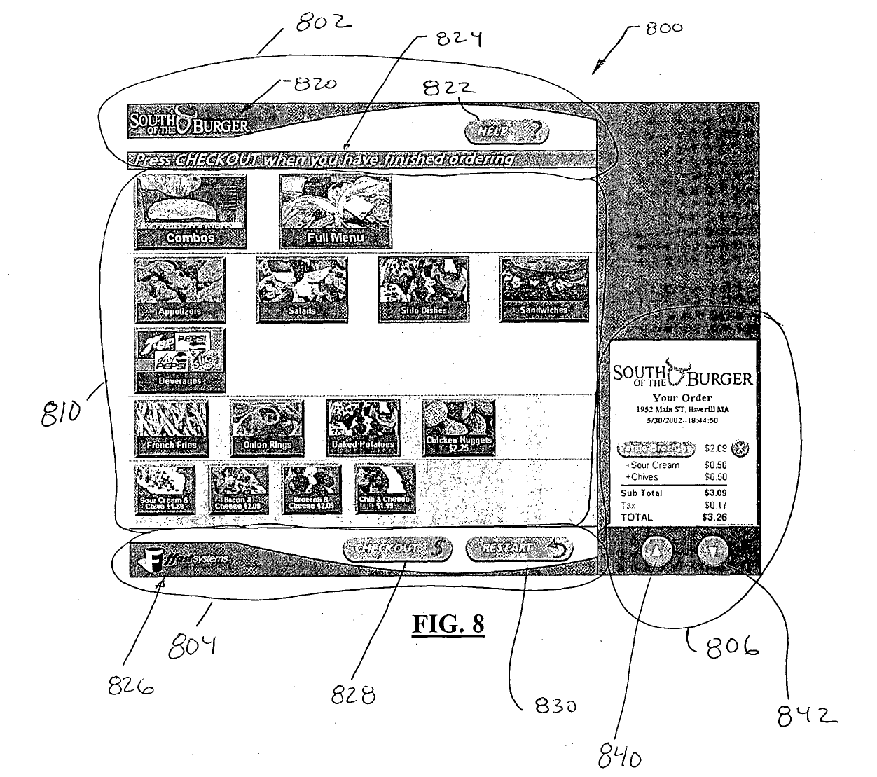

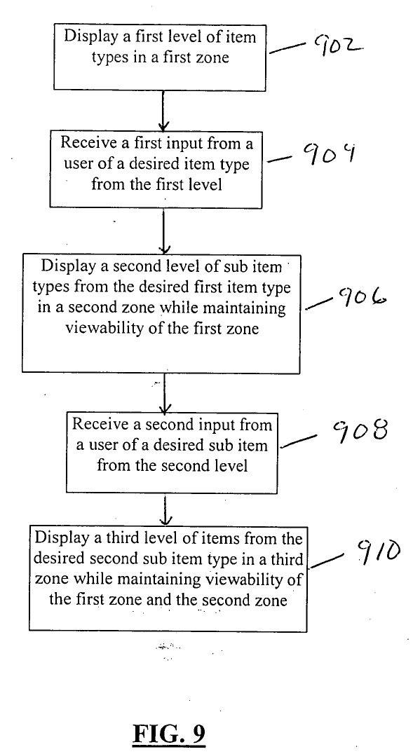

FIG. 8 is a graphical image 800, or graphical user interface (GUI) in accordance with the first exemplary embodiment of the invention. The graphical image 800 may be displayed on a touch screen or other visual display device to assist a user in composing an order. The image may have a banner frame 802, a footer frame 804, a receipt frame 806, and menu frame 810.

The banner frame 802 may contain a restaurant logo 820, a help button 822 and instructional text 824. The instruction text 824 may be animated to attract attention of a user. The instruction text 824 can either become exposed from left to right (as if it were being typed) or can fly in from the left and bounce at the opposite margin.

The footer frame 804 may contain a logo 826 of a system manufacturer as well as a “forward” button 828 and a “back” button 830. The “forward” button 828 may progresses towards a purchase while the “back” button 828 may return to a previous display. Labels on these buttons 828, 830 have the ability to change depending on state to reflect the specific forward or back step that will be taken. For example, the “forward” button may say “checkout” or “finish,” while the back button may say “restart” or “back to ordering.” When an item is added to an order, the “forward” button may be animated (e.g., flash) to attract attention of the user to the way to advance to the next step (e.g., checkout).

The receipt frame 806 may contain a virtual receipt printer that lists the items ordered along with their price, options, subtotal, taxes and total. Up button 840 and down button 842 allow the virtual receipt to be fed up or down, respectively. Touch areas on the virtual receipt allow items to be edited (e.g., change options) or removed from the order. When the order is complete, the virtual receipt may be ejected upward or downward, leaving the top or bottom of the display. Ejection of the virtual receipt is preferably timed to coincide with the printing of the actual paper receipt so that as the virtual receipt leaves either the upper or lower edge of the display, the paper receipt begins to emerge from the printer, which pushes the paper out an opening behind the virtual receipt printer. This creates the effect of the virtual receipt appearing to materialize as paper from the edge of the display. This may help draw attention of the user to the presence of the receipt, which may contain the order number of the user, and which the user may be expected to remove and keep until the order is fulfilled.

The menu frame 810 may display a restaurant or other vendor menu to a user and may allow the user to select desired items. The menu frame 810 may also be used for selecting order style (dine-in vs. take-out) confirming items, selecting options, selecting payment method, confirming payment and to present a closing message to the user when the order is complete. The function of the menu frame 810 is dependent on the state of the view. The details of interactions at each view state are discussed below.

FIG. 9 is a flow chart illustrating a menu presentation method in accordance with the first exemplary embodiment of the invention. The menu is preferably presented to the user in hierarchical fashion based on broad categories at the top of the hierarchy and specific, orderable items, at the bottom. Categories of items may be represented by icons, each preferably containing three discrete functional zones including a picture, a name for the category, and a border. The name may be displayed in a desired language (to be discussed below) and the border may change color to indicate a selection state of the item (normal or selected).

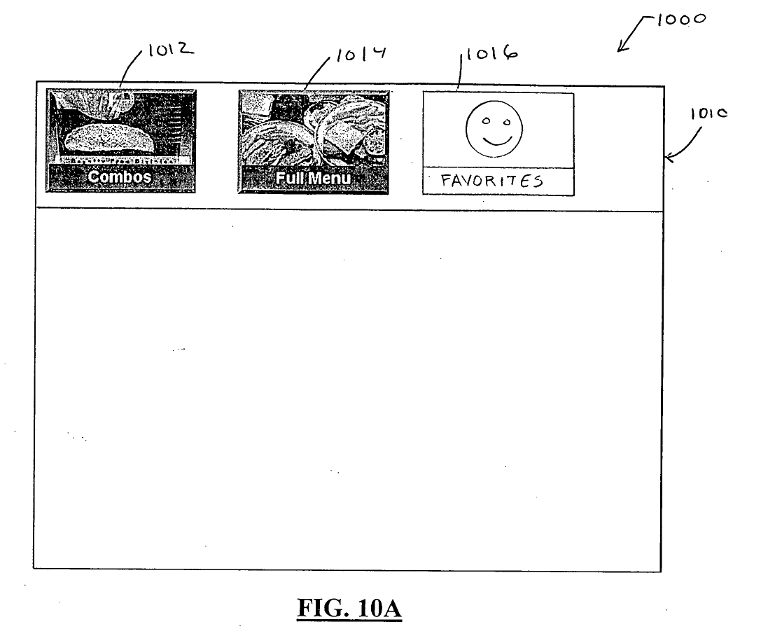

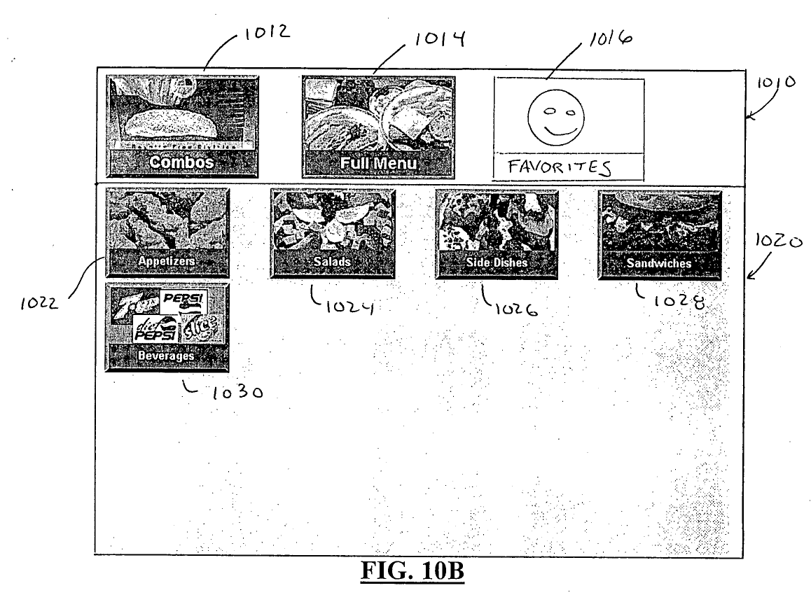

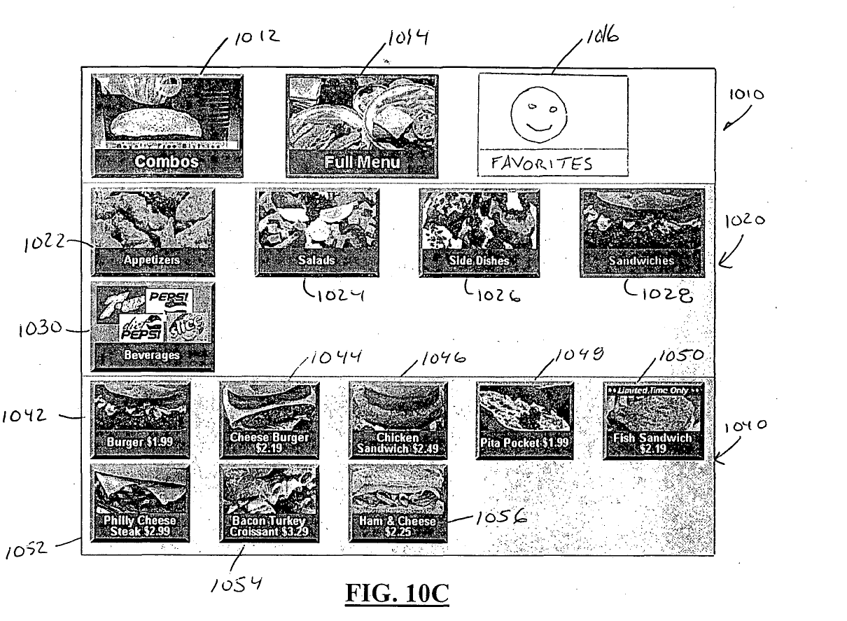

The following describes FIGS. 9, 10A, 10B, and 10C. As shown by FIG. 9, the self-service system may display a first level of item types in a first zone 1010 (see FIG. 10A) for selection by a user (block 902). The first item type may be a choice of a plurality of icons representing items, for example a combination order 1012, a full menu 1014, or a “my favorites” 1016 (to be discussed below). The user may choose a desired item type by selecting an icon in the first zone. In the example shown, icon 1014, “full menu” was selected.

The self-service system receives a first input from the user (block 904) and then displays a second level of sub-item type 1022-1030 in a second zone 1020 (see FIG. 10B), while maintaining viewability of the first zone 1010 (block 906). The user may then choose a desired sub-item type by selecting an icon in the second zone 1020. In the example shown, sub-item type 1028, “sandwiches,” was selected.

The self-service system receives a second input from the user (block 908) and then displays a third level of item icons 1042-1056 in a third zone 1040 (see FIG. 10C), while maintaining viewability of the first zone 1010 and the second zone 1020 (block 910). A price functional zone may be added to the icons for items at different levels (see item types 1042-1056 in FIG. 10C).

The separate zones 1010, 1020, and 1040 may have different backgrounds to help differentiate the zones. If the user makes an incorrect selection at any of the levels, the user can select an icon in a higher level in order to correct the mistake. The overall size of each icon in a zone may be smaller than in a higher zone, for example 25% smaller. By reducing the size of the icons in a zone, a larger quantity of icons can be displayed.

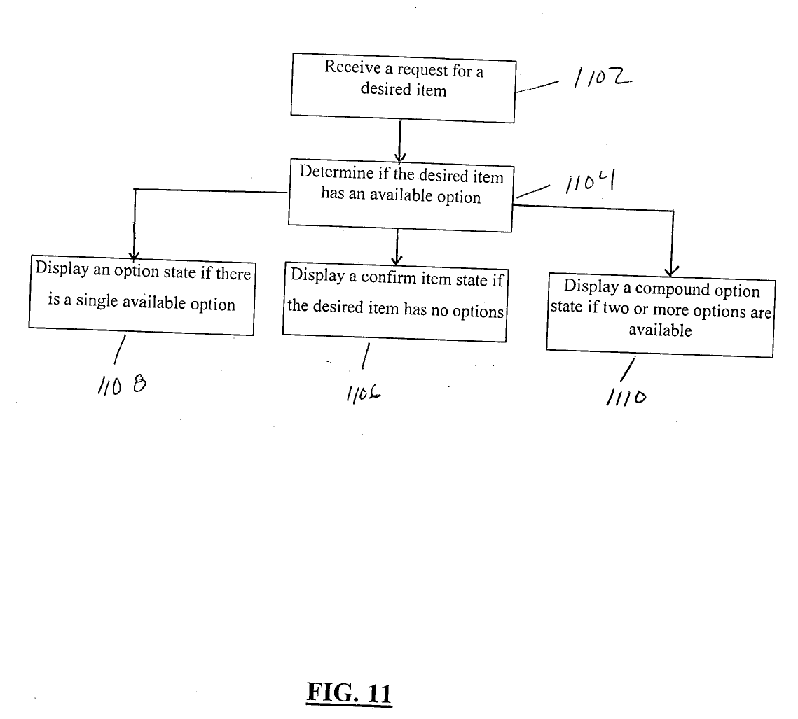

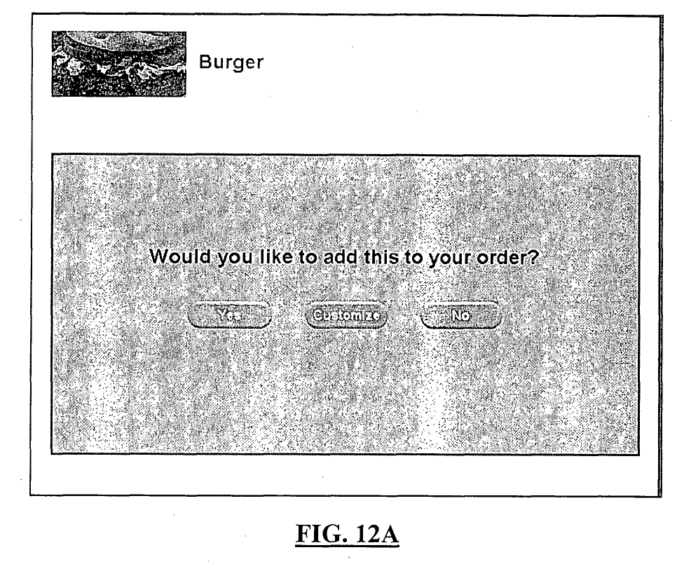

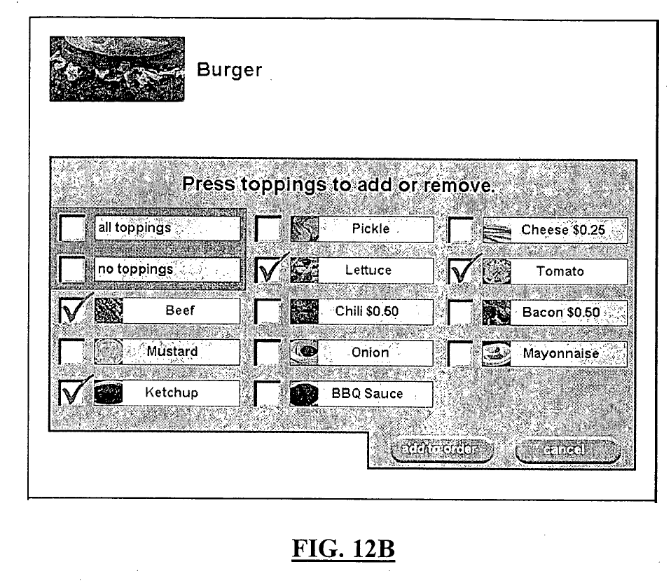

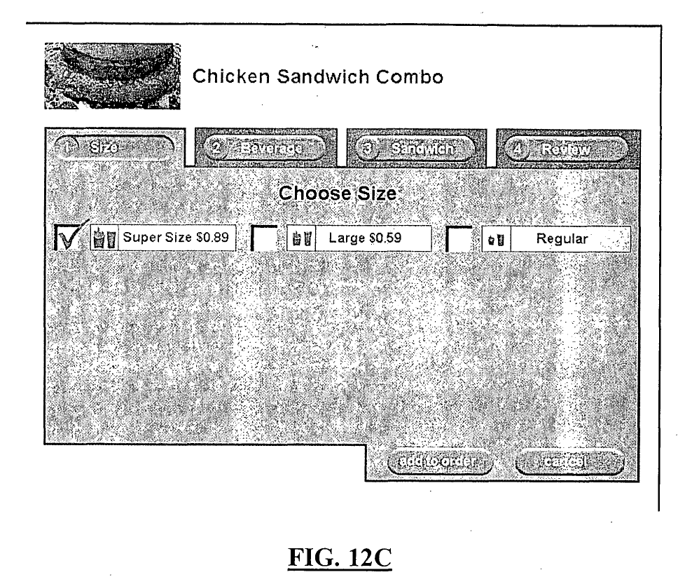

FIG. 11 is a flow chart illustrating an option menu presentation method in accordance with the first exemplary embodiment of the invention. During the ordering process, the self-service system may receive a request for a desired item (block 1102). The system then determines if the desired item has an available option (block 1104). If the system determines that there are no available options, the system displays a “confirm item” state (block 1106). The “confirm item” state can provide the user the opportunity to accept or decline the item after seeing a larger picture of the item. A graphical example of a “confirm item” state is shown in a graphical image provided by FIG. 12A, where the user can select only one of a variety of choices.

If the self-service system determines that there is only a single available option, the system displays a “single available option” state (block 1108) i.e., the user may only select one of the available options. Selection of one choice will preferably deselect any previous choice. A graphical example of a single available option state is shown in a graphical image provided by FIG. 12B, where the user may select one, and only one, of a variety of options.

If the self-service system determines that there are two or more options that can be selected, the system displays a “compound option” state (block 1110). The “compound option” can provide the user the opportunity to choose any option, all options, or no options. A graphical example of a “compound option” state is shown in a graphical image provided by FIG. 12C, where the user is able to select toppings for a food item, for example a hamburger. Note that one of the options may be “everything,” i.e., all toppings, and another option may be “plain,” i.e., no toppings. Note also that the display may show a price associated with an additional cost option. As shown in FIG. 12C, certain options such as chili, cheese, and bacon, if selected, will cost the user more money than the standard price.

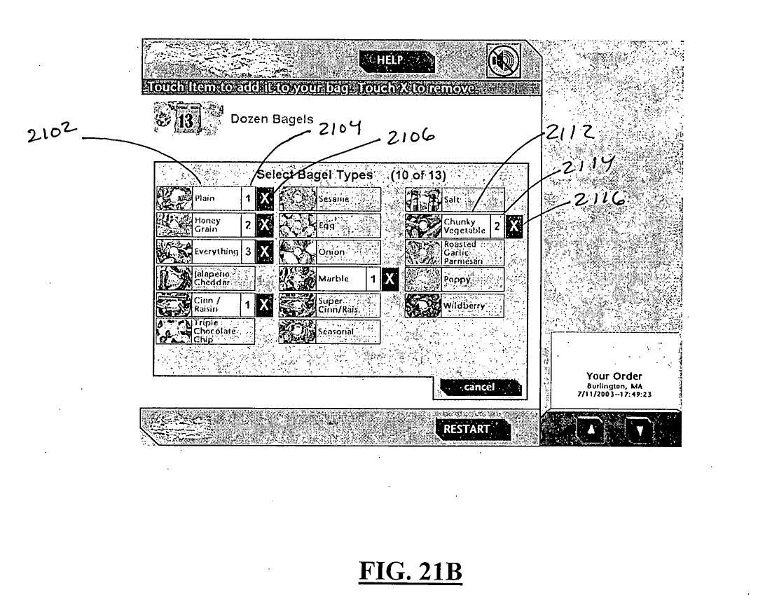

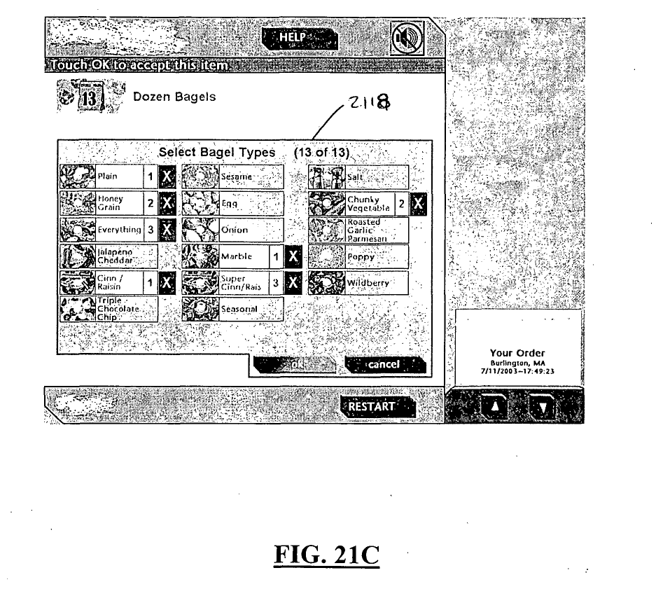

If the self-service system determines that a fixed quantity of options is available, the system displays a “pick N” option state in which no more than the fixed quantity (N) of items can be selected. A graphical example of a “pick N” option state is shown in a graphical image provided by FIG. 21A, where the user is able to select the items, for example bagels, that make up the maximum quantity, for example a bakers dozen, i.e., 13 bagels. Note in this “pick N” option state, the same option may be selected one or more times, for example, as shown by the graphical image provided by FIG. 12B, the user may select (1) plain, (2) honey grain, (3) everything, (1) cinnamon-raisin, (1) marble, and (2) chunky vegetable bagels to make up their baker's dozen.

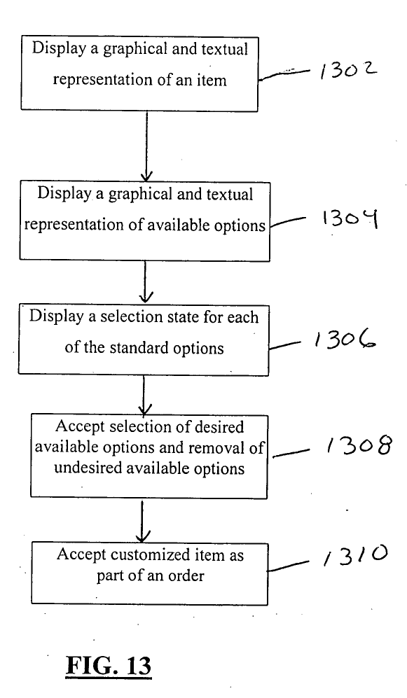

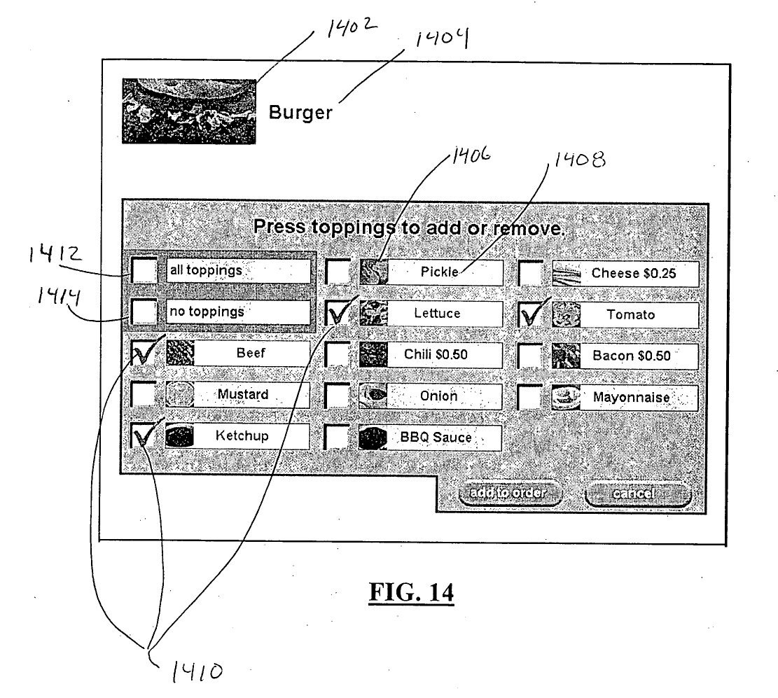

FIG. 13 is a flow chart illustrating a menu presentation method in accordance with a fifth embodiment of the invention. Describing FIG. 13 and a graphical representation provided by FIG. 14, during the ordering process, the self-service system may display a graphical representation 1402 and textual representation 1404 (see FIG. 14) of an item (block 1302). The self-service system may also display a graphical representation 1406 and textual representation 1408 of all the available options (block 1304) with a selection state 1410 displayed for each of the standard items (block 1306). The selection state of the standard options may be indicated with a “check” mark. In the example shown in FIG. 14, the standard options are a beef patty, ketchup, lettuce and tomato. The self-service system may then allow a user to select desired options and deselect undesired options (block 1308). The system may then accept the customized item as part of an order (block 1310).

Selecting the “all toppings” option 1412 may cause all of the options not designated as “extra” to be selected and all the “extra” option to be deselected. Alternatively, the “all toppings” option 1412 can cause all options, including “extras” to be selected. In the example illustrated by FIG. 14, the “extra” options include chili, cheese, and bacon.

Selecting the “no toppings” option 1414 causes all the options designated “plain” to be selected and all other options to be deselected. In the example shown in FIG. 14, the beef patty may be the only “plain” option selected when “no toppings” is selected.

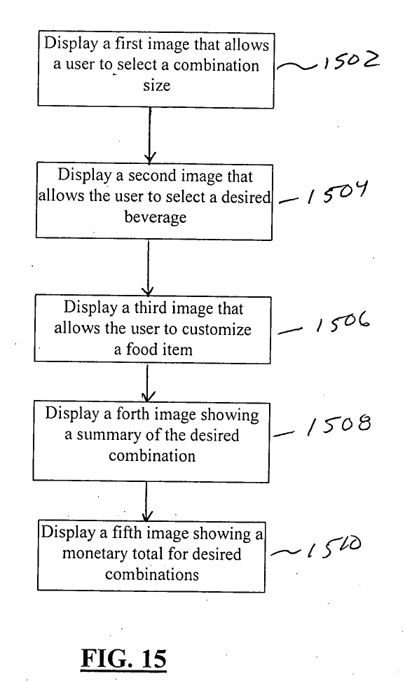

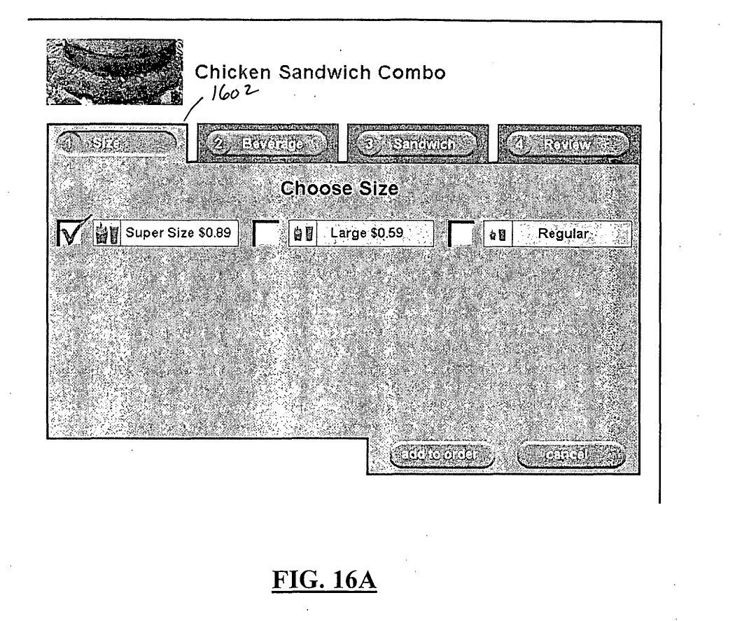

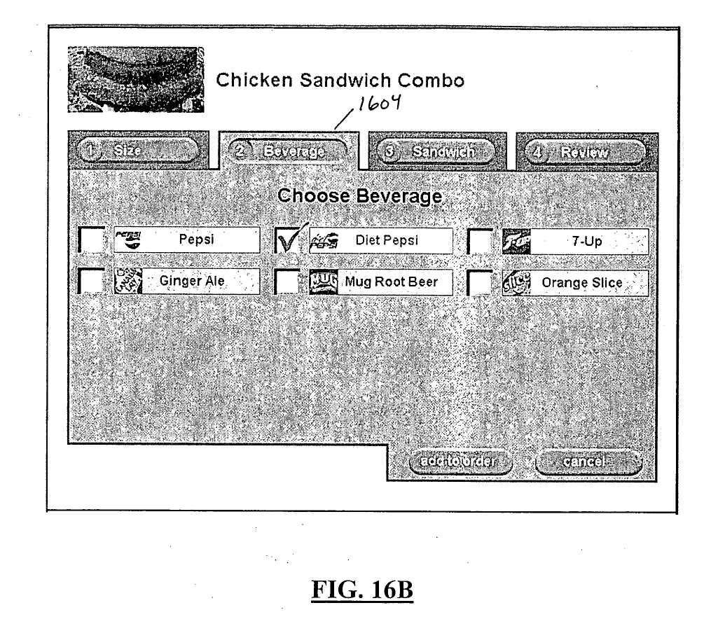

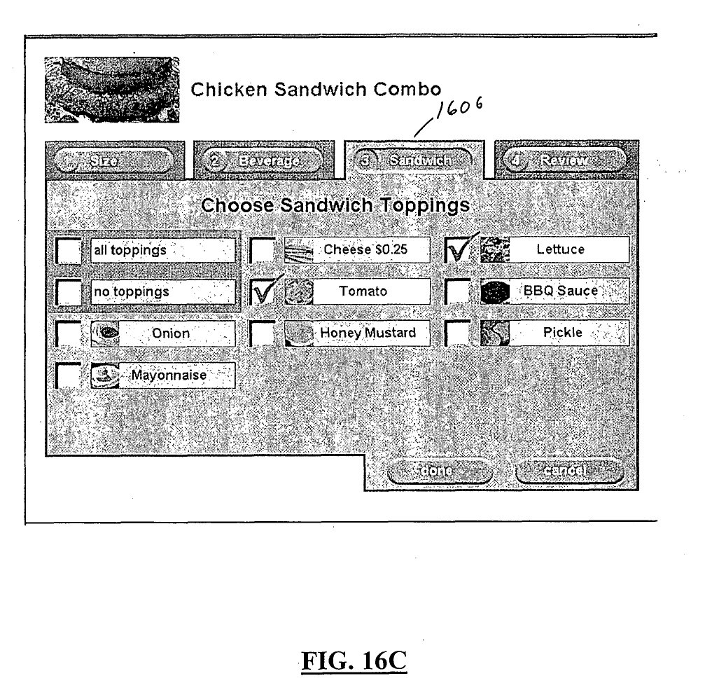

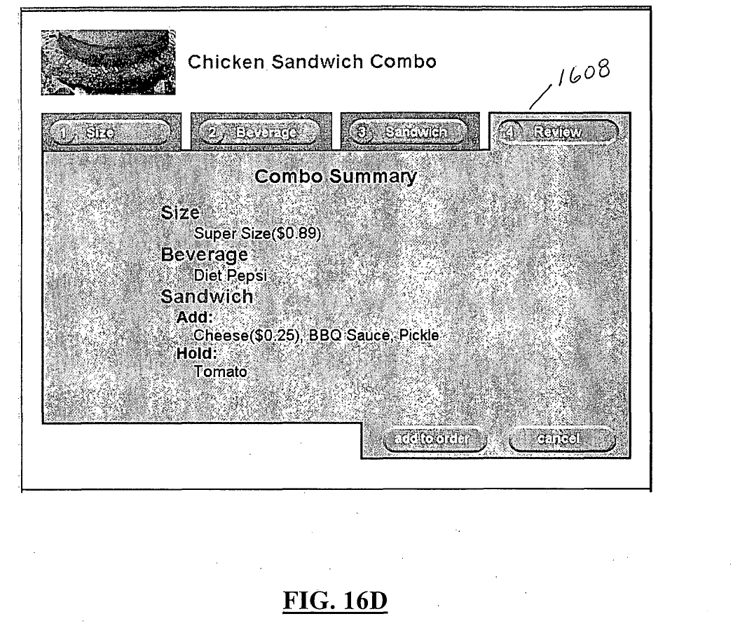

FIG. 15 is a flow chart illustrating a menu presentation method in accordance with a sixth exemplary embodiment of the invention. The method may allow a user to quickly compose, review, and modify, if necessary, an order. As shown by FIG. 15, the self-service system displays a first image (see FIG. 16A) that allows the user to select a combination size when a first tab 1602 is selected (block 1502). The self-service system displays a second image (see FIG. 16B) that allows a user to select a desired beverage when a second tab 1604 is selected (block 1504). The self-service system displays a third image (see FIG. 16C) that allows a user to customize a food item when a third tab 1606 is selected (block 1506). The self-service system displays a review image (see FIG. 16D) that allows a user to view a summary of the desired combination when a fourth tab 1604 is selected (block 1508).

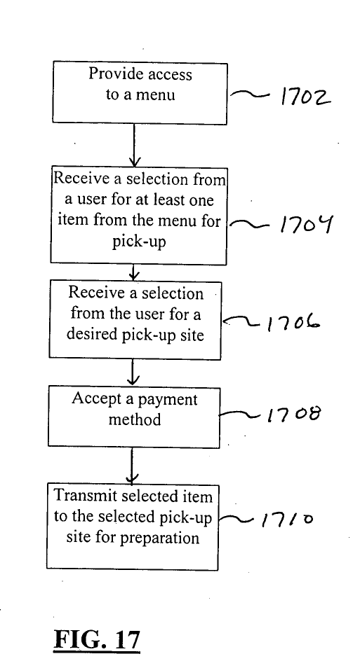

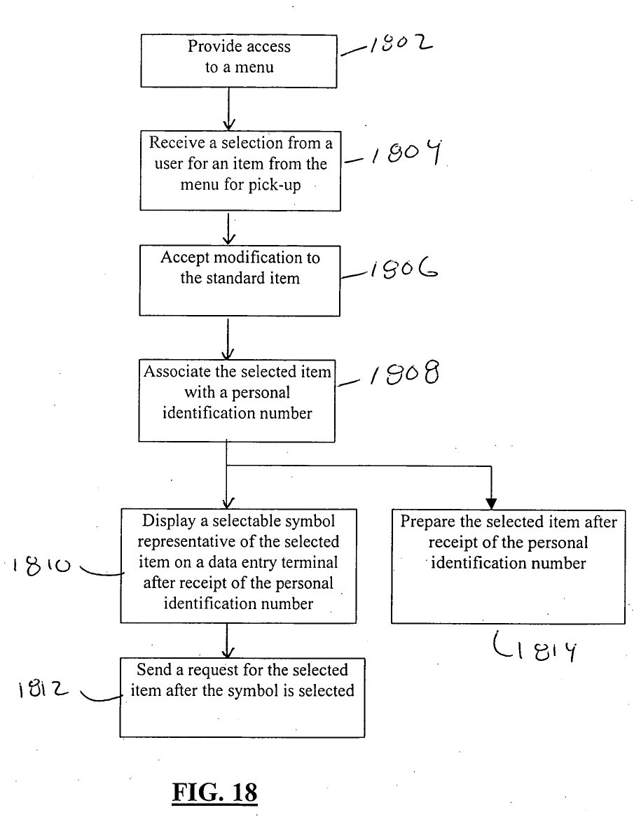

FIG. 17 is a flow chart illustrating an ordering method in accordance with a seventh exemplary embodiment of the invention. This method may provide a user with the ability to order items through a network, for example the Internet, for pickup at a local restaurant. The user may access the menu through an electronic device. As shown by FIG. 17, the self-service system provides access to a menu (block 1702). The self-service system receives a selection from a user for at least one item, for example a cheeseburger, for pick up (block 1704). The self-service system also receives a selection from the user for a desired pick-up site, for example the McDonalds® restaurant around the corner (block 1706). The system accepts payment, for example through a credit, debit, or loyalty card (block 1708) and transmits the selected item to the desired pick-up site for preparation (block 1710). The system may communicate directly with the point-of-sale system 706 in the restaurant without human interaction.

FIG. 18 is a flow chart illustrating an ordering method in accordance with an eighth exemplary embodiment of the invention. This method may provide a user with the ability to save a favorite meal to be ordered at a later date. As shown by FIG. 18, the self-service system provides access to a menu (block 1802). A user may access the menu through a connected device, for example a personal computer, a personal digital assistant (PDA), a phone, or other electronic device. The menu may be displayed in a textual format or graphical format, as described above, on the device. The self-service system may receive a selection from the user for an item(s) from the menu for take out (block 1804). The user may want the item “as is” or may want to modify the item. The self-service system accepts modifications to the standard item (block 1806), for example the self-service system may allow the user to customize a sandwich as described above. The self-service system then associates the selected item (standard or modified) with a personal identification number (PIN) (block 1808). The PIN may be any combination of characters that identifies a user, for example the system may associate the selected/modified item with a user's name, credit card number, social security number, driver's license number, or generated number. The association of the selected item and the PIN may then be stored in memory. The self-service system may display a selectable symbol representative of the selected item on a self-service terminal 300 after the system receives the PIN (block 1810). For example, the user may approach the self-service terminal 300 and swipe their card through a magnetic card reader, type in the PIN manually, or audibly enter the PIN. The self-service system may then send a request for the selected item to the kitchen 108 after the symbol is selected (block 1812). Alternatively, the selected item can be prepared after receipt of the PIN without displaying a selectable symbol.

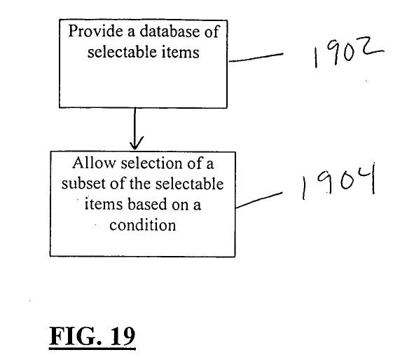

FIG. 19 is a flow chart illustrating a menu presentation method in accordance with a nineth exemplary embodiment of the invention. The method may display available items on a data-entry terminal based on a condition. As shown by FIG. 19, a system employing this menu presentation method has a database of selectable items (block 1902). The system, based on a condition, displays only the items that are presently available and allows a user to select any of the items (block 1904). By only displaying available items, the user will not be disappointed by seeing an item that cannot be ordered. The condition may be an inventory level, a restaurant profile, a weather condition, a time of the day, a day of the week, or day of the year. For example, if an item is out of stock, the item may not be displayed as being available; if the particular restaurant does not offer all items available at other restaurants in the same chain, the item may not be displayed as being available; if it is too hot outside, an item, like chili, may not be displayed as being available; and, certain items may not be displayed as being available if the time is before or after a certain time or during a certain time period, for example custom items may not be available during busy periods, a particular day of the week, for example omelets may only be available on Sundays, and a particular season, for example lobster may only be available in the summer. The system receives these inputs and adjusts the menu accordingly. The system may either not show an item that is presently not available, or it may show the item, but indicate that it is not available.

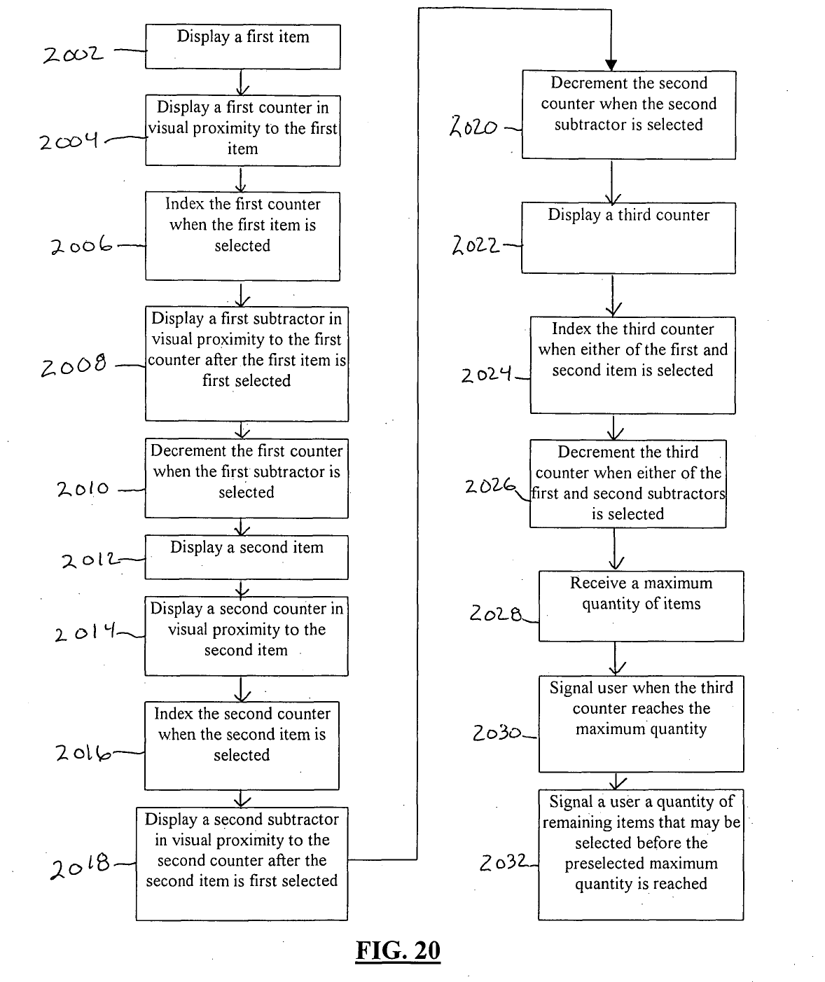

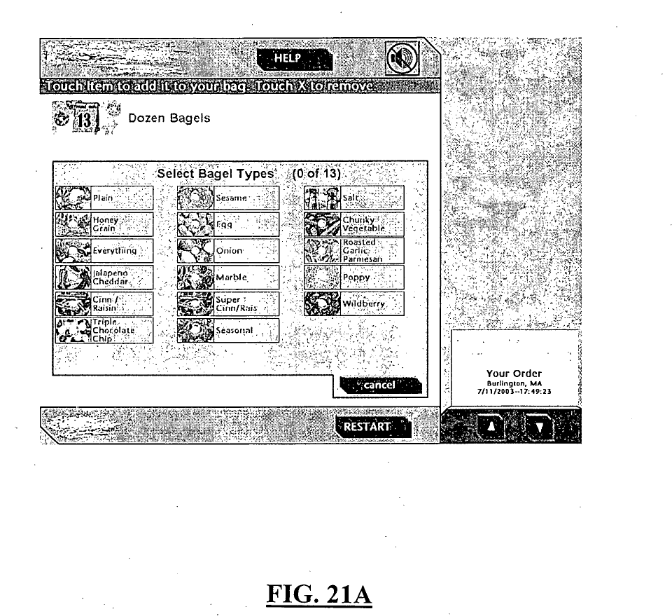

FIG. 20 is a flow chart illustrating a menu presentation method in accordance with a tenth exemplary embodiment of the invention and FIGS. 21A-C are graphical images or GUI in accordance with the tenth embodiment. This method may allow a user to visually see the make up of their order while composing the order. As shown by FIG. 20, the self-service system can display a first item 2102 (block 2002) with a first counter 2104 in visually proximity to the first item 2102 (block 2004). Visual proximity is intended to mean that the counter is visibly associated with the item, i.e., that a user would think the counter corresponds to the item. The self-service system may index the first counter 2104, i.e., add a unit increment, typically one, to the present counter when the first item 2102 is selected (block 2006). The self-service system may display a first subtractor 2106 in visually proximity to the first counter 2104 (block 2008). The first subtractor 2106 may be displayed only after the first item 2102 is selected. The first subtractor 2106 decrements, i:e., reduces, the first counter 2104 when selected (block 2010).

The self-service system can display a second item 2112 (block 2012) with a second counter 2114 in visually proximity to the second item 2112 (block 2014). The self-service system may index the second counter 2114 when the second item 2112 is selected (block 2016). The self-service system may display a second subtractor 2116 in visually proximity to the second counter 2114 (block 2018). The second subtractor 2116 may be displayed only after a second item 2112 is selected. The second subtractor 2116 decrements the second counter 2114 when selected (block 2020).

The self-service system may display a third counter 2118 (block 2022). The third counter 2118 may keep track of the total of the selected first item 2102 and the second item 2112 and may be indexed if either the first item 2102 or the second item 2112 is selected (block 2024) or decremented if either the first subtractor 2106 or the second subtractors 2116 is selected (block 2026).

The self-service system may receive a maximum quantity of items that can be selected, for example if a baker's dozen is desired, the maximum quantity may equal 13 (block 2028). The self-service system may signal the user when the maximum quantity is reached (block 2030) and/or signal the user a quantity of remaining items that may be selected before the maximum quantity is reached.

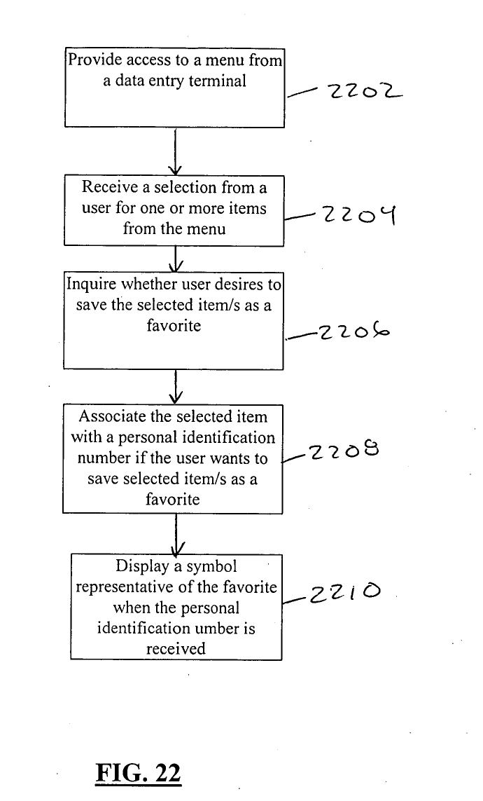

FIG. 22 is a flow chart illustrating an ordering method in accordance with an eleventh exemplary embodiment of the invention. The method may provide a user with the ability to save a favorite meal to be ordered again at a later date. As shown by FIG. 22, the self-service system can provide a user access to a menu from a self-service terminal 300 (block 2202). The system may receive a selection from the user for one or more items from the menu (block 2204). The system may then inquire whether the user wants to save the one or more selected items as a favorite (block 2206). A favorite may be a meal, for example two hamburgers, a large fry, and a medium coke, that the user wishes to get on a regular basis. A favorite allows the user to quickly order the same meal more quickly. If the user wants to save the selected item/s as a favorite, the system associates the item/s with a personal identification number (PID) (block 2208) and stores the association. The next time the system receives the PID, the system can display a symbol representative of the favorite (block 2210) for selection by the user. The system is capable of saving multiple favorites in memory.

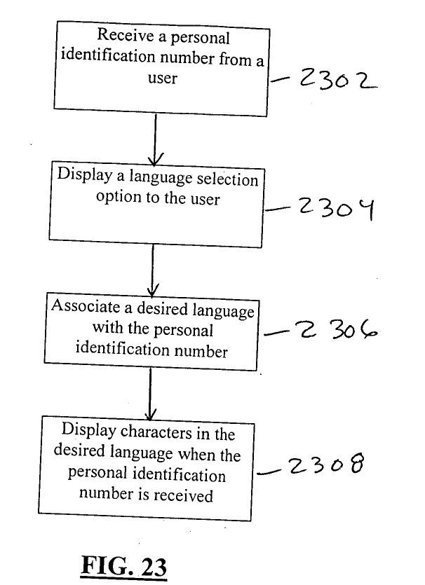

FIG. 23 is a flow chart illustrating a presentation method in accordance with a twelfth exemplary embodiment of the invention. The method may allow characters on a display screen to be displayed in a user's desired language without the user having to enter the language selection each time the user approaches a data-entry terminal. As shown by FIG. 23, the system receives a personal identification number (PID) from a user (block 2302). The system may then display a language selection screen to the user (block 2304). The language selection screen may have a variety of choices displayed in different languages. The user then selects the desired language and the system associates the selected language with the PID (block 2306) and saves it in memory. The next time the PID is received, the system displays the character on the display screen in the desired language without having to receive a desired language selection from the user. This can save the user the step of having to select the desired language each time the user approaches a data-entry terminal.

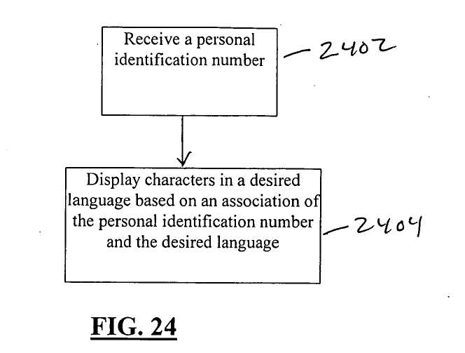

FIG. 24 is a flow chart illustrating a presentation method in accordance with a thirteenth exemplary embodiment of the invention. The method may allow characters on a display screen to be displayed in a user's desired language based on an association of a personal identification number (PID) and the desired language. As shown by FIG. 24, a data-entry terminal may receive the PID from a user when the user swipes their card through a magnetic card reader. The system then accesses an association, stored in memory, between the desired language and the PID and displays characters in the desired language. The association may be stored in memory by personnel when the user first receives their card or based on prior use by the user.

It should be emphasized that the above-described embodiments of the invention are merely some possible examples of implementation, set forth for a clear understanding of the principles of the invention. Many variations and modifications may be made to the above described embodiments of the invention without departing substantially from the spirit and principles of the invention. All such modifications and variations are intended to be included herein within the scope of this disclosure and the present invention, and protected by the following claims.

We claim:

1. A method of displaying a menu, comprising the steps of:
displaying a first level of item types in a first zone;
receiving a first input from a user of a desired item type from the first level;
displaying a second level of sub item types from the desired first item type in a second zone while maintaining viewability of the first zone;
receiving a second input from a user of a desired sub item from the second level; and
displaying a third level of items from the desired second sub item type in a third zone while maintaining viewability of the first and second zones.

2. The method of claim 1, wherein the first level of items are displayed as a first plurality of individual icons and the second level of items, are displayed as a second plurality of individual icons.

3. The method of claim 1, wherein a size of the individual icons making up the second plurality of icons is less than a size of the individual icons making up the first plurality of icons.

4. The method of claim 1, wherein a background of the first level is different than a background of the second level.

5. The method of claim 1, wherein the first level, the second level and the third level are displayed in a menu frame.

6. The method of claim 5, further comprising the step of displaying a receipt frame in visual proximity to the menu frame.

7. The method of claim 2, wherein the first, second, and third plurality of individual icons are a combination of a graphical image and text.

8. The method of claim 7, wherein the third plurality of individual icons further comprises a sale price.

9. An apparatus for displaying a menu comprising:
an enclosure;
a data input device;
a storage device comprising item types, sub item types, and items available for sale;
a video display terminal; and
a program configured to display a first level of item types from the storage device in a first zone of the video display terminal for a user to select from, a second level of sub item types in a second zone of the video display terminal for a user to select from while maintaining viewability of the first zone, and a third level of items in a third zone of the video display terminal for a user to select from while maintaining viewability of the first zone and the second zone.

10. The apparatus of claim 9, further comprising a bill acceptor, a bill returner, a coin returner, and a card reader enclosed within the enclosure.

11. The apparatus of claim 9, wherein the card reader is a selected one of a magnetic strip reader and an optical reader.

12. The apparatus of claim 9, wherein the memory further comprising a first, a second, and a third plurality of individual icons displayable on the visual display device.

13. The apparatus of claim 9, wherein the memory further comprises a sale price for each of the third level items.

14. A method of processing an order for pick up at a selected pick-up site, comprising the steps of:
providing access to a menu;
receiving a selection from a user for at least one item from the menu for pick-up;
receiving a selection from the user for a desired pick-up site;
accepting payment; and
transmitting data indicative of the selection to an order preparation system.

15. The method of claim 14, further comprising the step of preparing the selection at the selected pick-up site.

16. A method of providing ordered items, comprising the steps of:
receiving addressable data specifying a user-selected item, wherein the addressable data specifies a destination; and
preparing the user-selected item for receipt by a user at the destination.

17. The method of claim 16, wherein the addressable data includes a store location.

18. The method of claim 16, wherein the received data includes preparation instructions for the user-selected item.

19. The method of claim 16, wherein the addressable data is formatted to communicate with an order preparation system at the destination.

20. The method of claim 16, wherein the user-selected item is received through the Internet.

21. A method of creating a custom take-out menu for display at a data-entry terminal, comprising the steps of:
providing access to a menu having a plurality of items;
accepting modifications to at least one of the items from the menu for pick up; and
associating the modified item with a personal identification number.

22. A method of displaying a custom take-out menu at a data entry terminal, comprising the steps of:
providing access to a menu;
receiving a selection from a user for an item from the menu for pick-up;
receiving a personal identification number;
associating the selected item with the personal identification number; and
displaying a selectable symbol representative of the selected item on the data entry terminal after receipt of the personal identification number.

23. The method of claim 22, further comprising the step of allowing the user to customize the selected item.

24. The method of claim 22, further comprising the step of allowing the user to select one or more additional items to be associated with the personal identification number.

25. A method of preparing an item for pick up, comprising the steps of:
providing access to a menu;
receiving a selection from a user for an item from the menu for pick-up;
receiving a personal identification number;
associating the selected item with the personal identification number; and
preparing the selected item after receipt of the personal identification number.

26. The method of claim 25, further comprising the step of allowing the user to customize the selected item.

27. The method of claim 25, further comprising the step of allowing the user to select one or more additional items to be associated with the personal identification number.

28. A method of selecting options for an orderable item, comprising the steps of:
receiving a request for a desired item;
determining if the desired item has an available option;
displaying a confirm item state if the desired item has no options;
displaying an option state if there is a single available option; and
displaying a compound option state if two or more options are available.

29. A method of displaying options for a customizable item, comprising the steps of:
displaying a graphical and textual representation of the item;
displaying a graphical and textual representation of available options;
displaying a selection state for each of the standard options;
allowing selection of desired available options and removal of undesired available options; and
allowing the user to add the customized item to an order.

30. A method of ordering a customizable food and beverage combination, comprising the steps of:
displaying a first image that allows a user to select a combination size;
displaying a second image that allows the user to select a desired beverage;
displaying a third image that allows the user to customize a food item; and
displaying a forth image showing a summary of the desired combination.

31. The method of claim 30 further comprising the step of displaying a fifth image that allows the user to select a desired payment option.

32. The method of claim 30 further comprising the step of allowing the user to add the combination to an order.

33. The method of claim 30, further comprising the step of allowing the user to select between any of the first, second, third, and forth images for viewing.

34. The method of claim 30, wherein the second image is displayed after the user selects a combination size.

35. The method of claim 30, wherein the third image is displayed after the user selects a beverage.

36. The method of claim 30, wherein the third image inquires whether the user wants to customize the food item.

37. The method of claim 30, wherein the third image allows the user to select desirable options for the food.

38. A method of ordering a customizable food and beverage combination, comprising the steps of:
displaying a first tab, that when selected allows a user to select a combination size;
displaying a second tab, that when selected allows the user to select a desired beverage;
displaying a third tab, that when selected allows the user to customize a food item; and
displaying a forth tab, that when selected displays a summary of the desired combination.

39. A method of displaying characters in a desired language, comprising the steps of:
receiving a personal identification number;
determining a desired language associated with personal identification number; and
displaying characters in the desired language.

40. The method of claim 39, wherein the desired language is determined based on a language selection stored in memory.

41. The method of claim 39, further comprising the step of associating the desired language with the personal identification number after a user is prompted to select the desired language.

42. A method of displaying characters in a desired language, comprising the steps of:
receiving a personal identification number from a user;
displaying a language selection option to the user; and
associating a desired language with the personal identification number; and
displaying characters in the desired language when the personal identification number is received.

43. A method of presenting a menu for selection of items, comprising the steps of:
accessing a database of selectable items; and
displaying a subset of the selectable items based on a condition

44. The method of claim 43, wherein the condition is an inventory level.

45. The method of claim 43, wherein the condition is a restaurant profile.

46. The method of claim 43, wherein the condition is a weather characteristic.

47. The method of claim 43, wherein the condition is a time of day.

48. The method of claim 43, wherein the condition is a day of the week.

49. The method of claim 43, wherein the condition is a day of the year.

50. The method of claim 43, wherein the condition is a combination of two or more of an inventory level, a restaurant profile, a weather characteristic, a time of day, a day of the week, and a day of the year.

51. A method of allowing a user to customize an order, comprising the steps of:
displaying a first item;
displaying a first counter in visual proximity to the first item;
indexing the first counter when the first item is selected; and
displaying a first subtractor in visual proximity to the first counter after the first item is first selected.

52. The method of claim 51, further comprising the step of decrementing the first counter when the first subtractor is selected.

53. The method of claim 51, further comprising the step of
displaying a second item;
displaying a second counter in visual proximity to the second item;
indexing the second counter when the second item is selected; and
displaying a second subtractor in visual proximity to the second counter after the second item is first selected;

54. The method of claim 53, further comprising the step of decrementing the second counter when the second subtractor is selected.

55. The method of claim 53, further comprising the step of displaying a third counter, the third counter maintaining a sum of the first items and the second items.

56. The method of claim 55, further comprising the step of indexing the third counter when either of the first and the second items are selected.

57. The method of claim 56, further comprising the step of receiving a maximum quantity of items.

58. The method of claim 57, further comprising the step of signaling a user when the third counter reaches the maximum quantity.

59. The method of claim 57, further comprising the step of signaling a user a quantity of remaining items that may be selected before the maximum quantity is reached.

60. The method of claim 55, further comprising the step of decrementing the third counter when either of the first and the second subtractors is selected.

61. A method of allowing a user to customize an order, comprising the steps of:
displaying a first option;
displaying a confirmation symbol in proximity to the first option if the first option is selected a first time; and
removing the symbol if the first option is selected a subsequent time.

62. A method of displaying a custom take-out menu at a data entry terminal comprising the steps of:
providing access to a menu from a data entry terminal;
receiving a selection from a user for an item from the menu;
associating the selected item with a selectable symbol representative of the selected item; and
sending a request for the selected item when the selectable symbol is selected.

63. A system for processing an order, comprising:
a customer touch point;
a transaction manager; and
a point-of-sale system, the transaction manager adapted to receive an order from the customer touch point and transmit the order to the point of sale system.

64. A system for processing an order, comprising:
a data-entry means;
a data processing means; and
a point-of-sale system, the data processing means adapted to receive an order from the data-entry means and transmit the order to the point-of-sale system.
